(19) United States
(12) Patent Application Publication
(10) Pub. No.: US 2006/0008172 A1
(43) Pub. Date: Jan. 12, 2006

(54) Image compensating system and method for a mobile terminal imaging device

(75) Inventor: In-Sup Choi, Incheon (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5534, US

(73) Assignee: LG Electronics Inc.

(21) Appl. No.: 11/176,934

(22) Filed: Jul. 5, 2005

(30) Foreign Application Priority Data
Jul. 6, 2004 (KR) 10-2004-52365

(51) Int. Cl. G06K 9/40; G06K 9/36

(52) U.S. Cl. 382/254; 382/289

(57) ABSTRACT

An image correction system for a mobile communication terminal having a camera is provided. In one embodiment, the image correction system comprises a processing unit for detecting and correcting an undesirable image orientation for an image captured by the camera, wherein the undesirable orientation is calculated according to a first reference line formed by a pixel of quasi-color information in the captured image.

### CROSS-REFERENCE TO RELATED APPLICATION

Pursuant to 35 U.S.C. § 19(a), this application claims the benefit of earlier filing date and right of priority to Korean Application No. 10-2004-52365, filed on Jul. 6, 2004, the contents of which are hereby incorporated by reference herein in their entirety.

### FIELD OF THE INVENTION

The present invention relates to a mobile terminal having a camera and, more particularly, to an image compensating apparatus of a mobile terminal having for automatically compensating an inclination of a photographed image.

### BACKGROUND OF THE INVENTION

A mobile terminal can wirelessly communicate with another terminal through a mobile switching center (MSC) in a service region of a base station. Third generation mobile communication systems provide voice and multi-media functions. A camera equipped mobile terminal can be used for transmitting/receiving a photographed image.

A mobile terminal having a camera is provided with a camera for photographing an object and a display unit for displaying a photographed image on a screen. Generally, a display unit of a digital camera displays an image having a horizontal length longer than a vertical length. However, the display unit of the mobile terminal having a camera displays an image having a vertical length longer than a horizontal length.

FIGS. 1A and 1B are views showing images respectively displayed on a display unit of a digital camera and a display unit of a mobile terminal.

As shown in FIGS. 1A and 1B, the horizontal length (640 pixels) is longer than the vertical length (480 pixels) in an image having pixels more than 300 thousand (640×480). In case of using the digital camera, a displayed image has the same ratio between a horizontal length and a vertical length as that of a substantially stored image. Accordingly, even if a screen is inclined (i.e., tilted), a user detects the inclination or tilt in position.

However, in case of using the mobile terminal, an image is mainly displayed on a display unit having a rectangular shape with a vertical length longer than a horizontal length, as shown as the dotted line. Accordingly, when an image inclination is generated, the user can not easily detect the image inclination through the preview screen of the mobile terminal. Also, at the time of photographing an object by using the mobile terminal, the user photographs the object with one hand which can tremble. Thus, an image photographed by a mobile terminal is frequently inclined or blurred regardless of whether a sensor of a high picture quality is adopted or not.

### SUMMARY OF THE INVENTION

An image correction system for a mobile communication terminal having a camera is provided. In one embodiment, the image correction system comprises a processing unit for detecting and correcting an undesirable image orientation for an image captured by the camera, wherein the undesirable orientation is calculated according to a first reference line formed by a pixel of quasi-color information in the captured image.

The system may further comprise a memory unit for storing the captured image and a processing unit for detecting the undesirable image orientation by comparing the first reference line with a second reference line in the capture image outputted in line unit format.

The undesirable image orientation is caused by a tilting of the camera by a first angel A in a first direction, when the image was captured and, wherein the undesirable image orientation is corrected by rotating the captured image by a second angel B, in a second direction.

In a preferred embodiment, the second angel B is equal to the first angel A and the second direction is opposite the first direction. The memory unit comprises at least one of RAM for temporarily storing the captured image; and flash memory for storing a corrected image of the captured image.

In another embodiment, the system further comprises a digital signal processor for enhancing the speed of the processing unit by preprocessing data related to the captured image; a wireless communication unit for wirelessly communicating a signal comprising a corrected image of the captured image; and a display unit for displaying a corrected image of the captured image.

Depending on implementation, the captured image is stored in memory in at least one of YCbCr, YUV, and RGB formats. The processing unit detects the first reference line based on a Y value representing a luminance component, when the captured image is stored in YcbCr or YUV formats. In an alternate embodiment, the processing unit detects the first reference line based on a distribution of a G value, when the captured image is stored in an RGB format.

In another embodiments, the processing unit detects a Y value represented by M bits in the captured image, and if N bits of the M bits are equal, the Y value is set as the first reference line. In some embodiments, if the processing unit detects a G value represented by M bits in the captured image, and if N bits of the M bits are equal, the G value is set as the first reference line.

In accordance with yet another aspect of the invention, an image correction method for a mobile communication terminal having a camera are provided. The method comprises photographing an object using the camera; generating image data for the photographed object; detecting an undesirable image orientation according to a first reference line formed by a pixel of quasi-color information in the image data; and correcting the undesirable image orientation.

The detecting comprises determining a distribution of the image data by analyzing image data near center of the image, detecting a distribution of a Y value representing a luminance component of the image, when the image data is in YCbCr or YUV formats, or determining a distribution of a G value when the data is in RGB format.

In one embodiment, the detecting further comprises detecting the Y value represented by M bits in the captured image; and setting the Y value as the first reference line, if N bits of the M bits are equal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate exemplary embodiments of the invention and together with the description serve to explain the principles of the invention.

FIGS. 1A and 1B are views respectively showing an image on a display unit of a digital camera and an image on a display unit of a mobile terminal.

FIG. 2 is a block diagram of an image compensating apparatus of a mobile terminal having a camera therein according to a preferred embodiment of the present invention.

FIG. 3 is an exemplary view showing a reference line of image data for judging an image inclination according to one embodiment of the present invention.

FIG. 4 is a flowchart showing an image compensating method of a mobile terminal having a camera therein according to a preferred embodiment of the present invention.

FIG. 5A is an exemplary view showing an inclined image.

FIG. 5B is an exemplary view showing an image stored in a RAM in an inclined position.

FIG. 5C is an exemplary view showing a process for judging an image inclination according to one embodiment of the present invention.

FIG. 5D is an exemplary view showing a compensated image according to a preferred embodiment of the present invention.

FIG. 5E is an exemplary view showing an image cropping-processed for a region lost after the compensation according to a preferred embodiment of the present invention.

FIG. 5F is an exemplary view showing an image expansion-processed for the region lost after the compensation according to a preferred embodiment of the present invention.

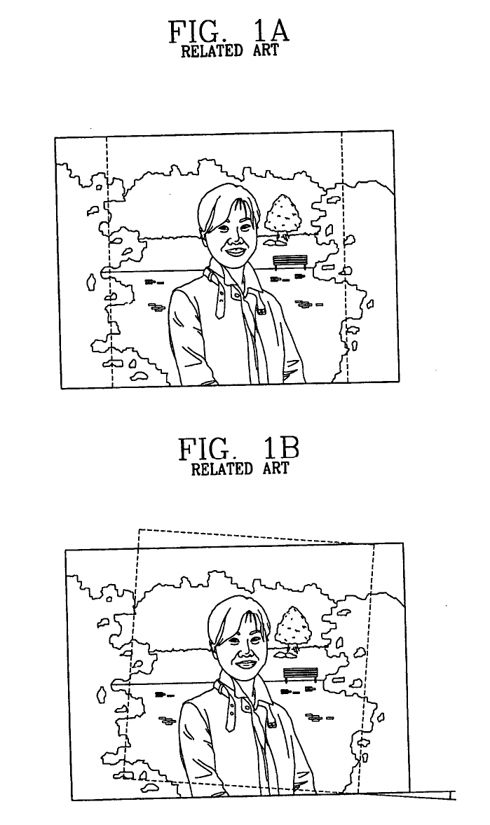

### DETAILED DESCRIPTION OF THE PREFERRED EMBODIMENTS

Reference will now be made in detail to the preferred embodiments of the present invention, examples of which are illustrated in the accompanying drawings.

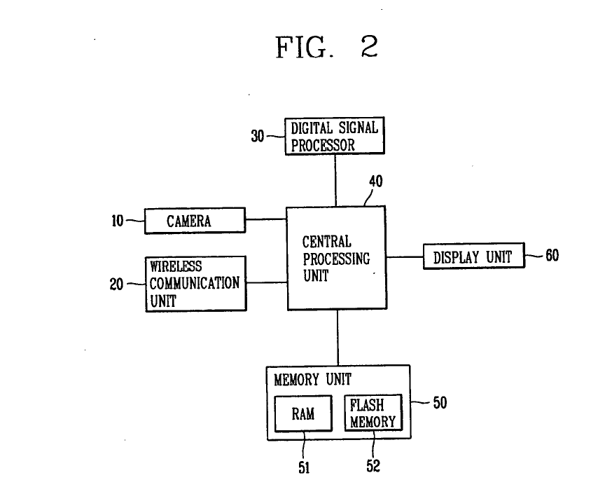

As shown in FIG. 2, the image compensating apparatus of a mobile terminal having a camera therein comprises a camera 10 for photographing an object and outputting image data of the photographed object. A central processing unit 40 is included for determining an inclination of an image based on a reference line formed by a pixel of quasi-color information. The image data outputted from the camera is analyzed when an image inclination is detected.

A digital signal processor 30 for performing an operation of a digital signal for the image data with a high speed and thereby supplementing the operation of the central processing unit 40 is also provided. A memory unit 50 for storing the image data supplied from the camera 10 or the central processing unit 40, a wireless communication unit 20 for wirelessly transmitting/receiving a communication signal, and a display unit 60 for displaying an image outputted from the camera or an image outputted from the central processing unit on a screen are also provided.

The memory unit 50 comprises a RAM 51 for temporarily storing the image data photographed by the camera 10, and a flash memory 52 for storing the image data that has been compensated by the central processing unit 40. The display unit 60 may comprise an LCD screen, but is not limited to the LCD screen.

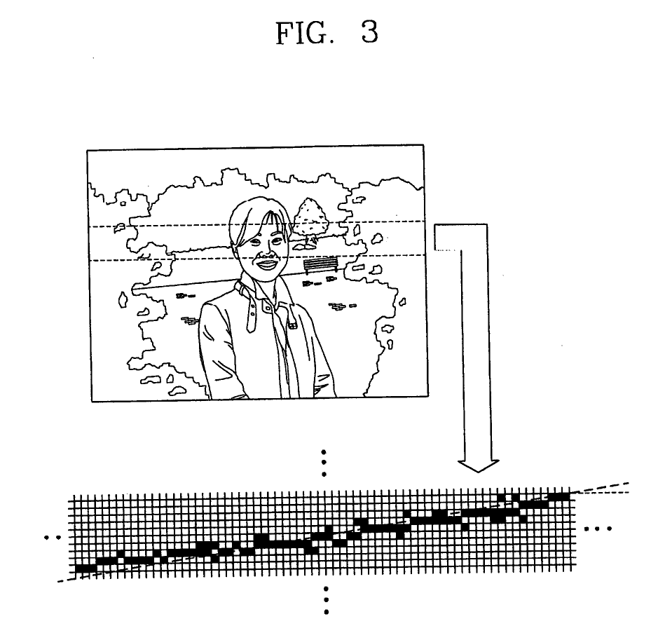

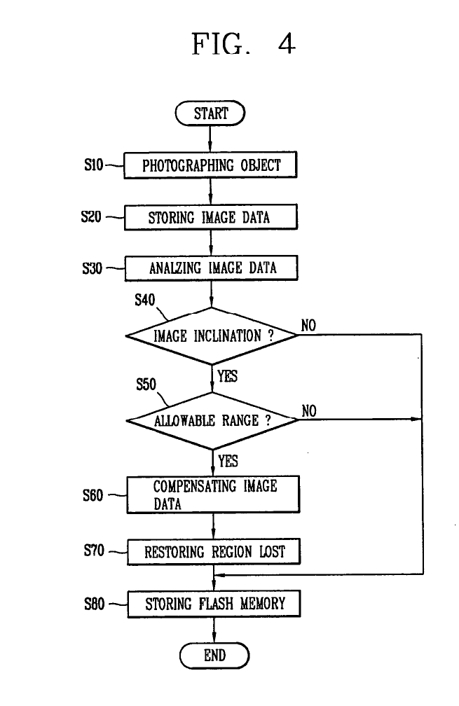

Referring to FIGS. 3 and 4, a user previews an image of an object to be photographed on the display unit 60 and photographs the object (S10). Then, the image of the object photographed by an image sensor of the camera 20 is temporarily stored in the RAM 51 (S20). The image data is stored in the RAM δ 1, for example, as a YcbCr format, a YUV format, or an RGB format.

The central processing unit 40 analyzes the photographed image data to determine whether the image is inclined or not (S30). For example, since the image data is outputted from the image sensor of the camera as a line unit and is displayed on a screen, the image data outputted as a line unit may be set as a reference line. The image data is analyzed thereby to detect a pixel of quasi-color information. By comparing the reference line of the image data outputted as a line unit with a reference line formed by the pixel of the quasi-color information, a gradient of the image can be obtained.

When it is determined that the image inclination has been generated (S40), the central processing unit 40 compensates the image inclination. For example, the compensation is performed by rotating the image in an opposite direction to the direction of the image gradient.

In one embodiment, central processing unit 40 determines whether the image inclination has been generated within an allowable range (S50). If the image inclination has been generated within the allowable range, the image data is compensated (S60). The image data is then restored in a region lost due to the image rotation in the compensation process into the original size (S70). The compensate image data is then stored of into the flash memory (S80). If the image has not been inclined, the image data is stored in the flash memory without being compensated.

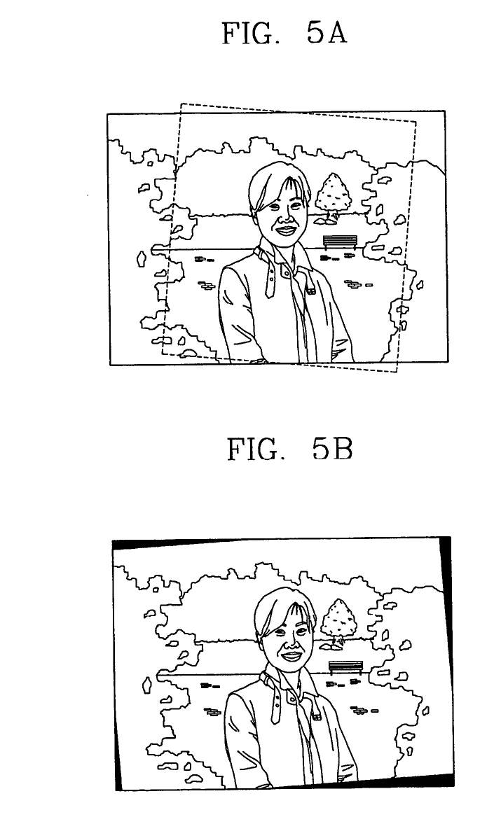

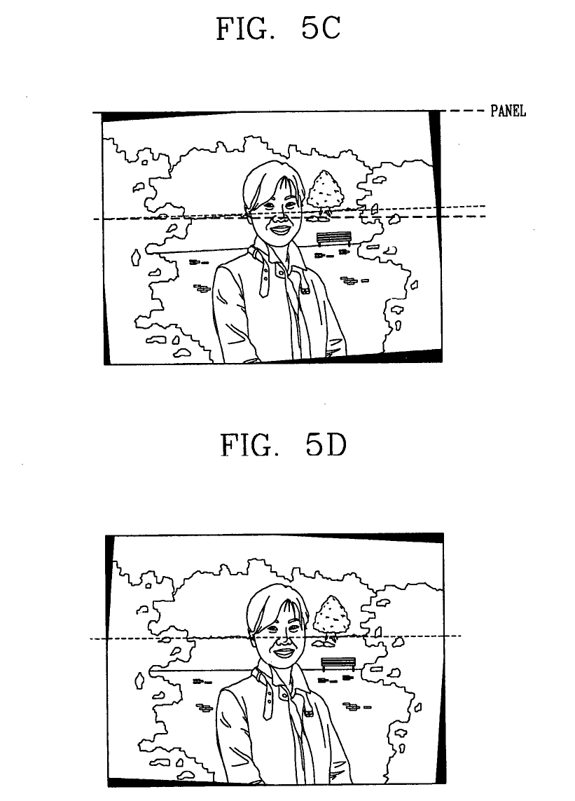

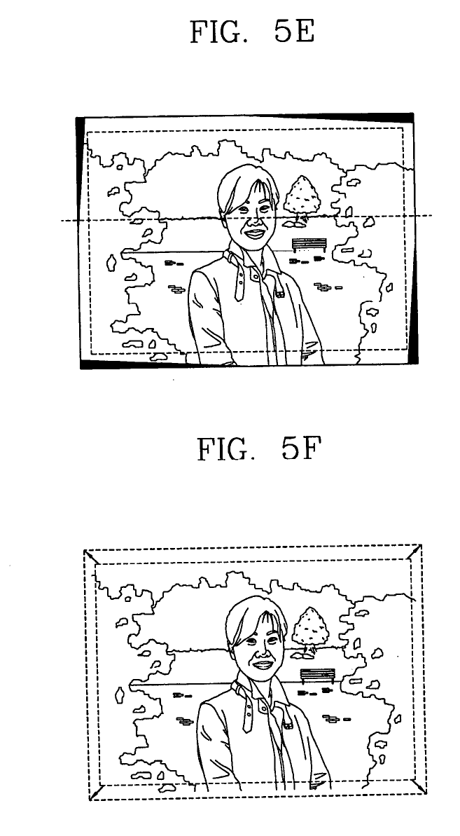

The image compensating method of a mobile terminal according to the present invention will be explained in more detail with reference to FIGS. 5A to 5E.

As shown in FIG. 5A, it is assumed that an object has been photographed by using the mobile terminal.

As shown in FIG. 5B, the photographed image is temporarily stored in the RAM 51 before being stored in the flash memory 52. A value outputted from the image sensor of the camera 10 is stored in the memory unit 50 as YCbCr, YUV, and RGB formats, for example.

As shown in FIG. 5C, the central processing unit 40 analyzes the image data stored in the RAM thereby to detect an image inclination (or error). That is, since an object is arranged at the center of a screen at the time of photographing, a distribution of the image data can be determined by analyzing output data near the center of the image. In the present invention, an image inclination is checked by detecting a distribution of a Y value, a luminance component when data outputted from the camera sensor is YCbCr and YUV and by determining a distribution of a G value when the data is RGB. A Y value or a G value is detected from image data outputted from the image sensor of the camera.

In one embodiment, based on the analyzed image data, an image inclination is determined by detecting quasi-color information among the image data stored in the RAM 51. For example, the image data outputted from the image sensor of the camera 10 is outputted as a line unit, so that a reference line of the image data of the line unit is determined as it is. Also, a reference line formed by a pixel of the quasi-color information is set by certifying a Y value or a G value, for example.

Considering that the image data outputted from the camera sensor is generally composed of 8 bits, if 6 bits of the Y value of the G value are equal to one another, the value is considered as the same color information thereby to set a reference line formed by a pixel of the quasi-color information.

As shown in FIG. 5D, if it is determined that an image inclination has been generated, it is determined whether the image inclination is within an allowable range or not. If the image inclination is within an allowable range, the image data is compensated. In a preferred embodiment, the allowable range is limited into a gradient within a range of 5 degree (5°) based on a horizontal line so that the compensated image can maintain a similar state as the original image. The image compensation is performed by rotating the image data in an opposite direction to the direction of the image inclination of the reference line formed by the pixel of the quasi-color information as much as the inclined angle based on the reference line of the image data of the line unit.

If the image inclination is not within an allowable range, the image compensation is not performed but the original image is stored in the flash memory.

As shown in FIGS. 5E and 5F, a region lost due to the image rotation at the time of the compensation process is processed. That is, since the image was rotated for the image compensation when the image inclination has been generated, a lost region is generated. Accordingly, the lost region is restored into the original size by cropping or enlarging the compensated image. Finally, the compensated image is stored into the flash memory 52 of the memory unit.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An image correction system for a mobile communication terminal having a camera, the image correction system comprising:
a processing unit for detecting and correcting an undesirable image orientation for an image captured by the camera, wherein the undesirable orientation is calculated according to a first reference line formed by a pixel of quasi-color information in the captured image.

2. The system of claim 1, further comprising a memory unit for storing the captured image.

3. The system of claim 1, wherein the processing unit detects the undesirable image orientation by comparing the first reference line with a second reference line in the capture image outputted in line unit format.

4. The system of claim 1, wherein the undesirable image orientation is caused by a tilting of the camera by a first angel A in a first direction, when the image was captured and, wherein the undesirable image orientation is corrected by rotating the captured image by a second angel B, in a second direction.

5. The system of claim 4, wherein the second angel B is equal to the first angel A.

6. The system of claim 5, wherein the second direction is opposite the first direction.

7. The system of claim 2, wherein the memory unit comprises at least one of:
RAM for temporarily storing the captured image; and
flash memory for storing a corrected image of the captured image.

8. The system of claim 1, further comprising a digital signal processor for enhancing the speed of the processing unit by preprocessing data related to the captured image.

9. The system of claim 1, further comprising:
a wireless communication unit for wirelessly communicating a signal comprising a corrected image of the captured image.

10. The system of claim 1, further comprising:
a display unit for displaying a corrected image of the captured image.

11. The system of claim 1, wherein the captured image is stored in memory in at least one of YCbCr, YUV, and RGB formats.

12. The system of claim 11, wherein the processing unit detects the first reference line based on a Y value representing a luminance component, when the captured image is stored in YcbCr or YUV formats.

13. The system of claim δ 1, wherein the processing unit detects the first reference line based on a distribution of a G value, when the captured image is stored in an RGB format.

14. The system of claim 11, wherein the processing unit detects a Y value represented by M bits in the captured image, and if N bits of the M bits are equal, the Y value is set as the first reference line.

15. The system of claim 11, wherein the processing unit detects a G value represented by M bits in the captured image, and if N bits of the M bits are equal, the G value is set as the first reference line.

16. An image correction method for a mobile communication terminal having a camera, the method comprising:
photographing an object using the camera;
generating image data for the photographed object;
detecting an undesirable image orientation according to a first reference line formed by a pixel of quasi-color information in the image data; and
correcting the undesirable image orientation.

17. The method of claim 16, wherein the detecting comprises:
determining a distribution of the image data by analyzing image data near center of the image.

18. The method of claim 17, wherein the detecting further comprises:
detecting a distribution of a Y value representing a luminance component of the image, when the image data is in YCbCr or YUV formats.

19. The method of claim 17, wherein the detecting further comprises determining a distribution of a G value when the data is in RGB format.

20. The method of claim 17, wherein the detecting further comprises:
detecting the Y value represented by M bits in the captured image; and
setting the Y value as the first reference line, if N bits of the M bits are equal.
